(19) United States
(12) Patent Application Publication
(10) Pub. No.: US 2015/0211085 A1
(43) Pub. Date: Jul. 30, 2015

(54) HEAT TREATMENT FOR VEHICLE SEAT STRUCTURES AND COMPONENTS

(71) Applicant: JOHNSON CONTROLS TECHNOLOGY COMPANY, Holland, MI (US)

(72) Inventors: Mark Anthony Harris, West Bloomfield, MI (US); Daniel J. Sakkinen, Highland, MI (US); Edward J. Lamont, Livonia, MI (US)

(73) Assignee: JOHNSON CONTROLS TECHNOLOGY COMPANY, Holland, MI (US)

(21) Appl. No.: 14/430,629

(22) PCT Filed: Sep. 16, 2013
(86) PCT No.: PCT/US2013/059920

§ 371 Date: Mar. 24, 2015

Related U.S. Application Data
(60) Provisional application No. 61/711,041, filed on Oct. 8, 2012.

(51) Int. Cl. C21D 1/40; B21D 22/02; B60N 2/68; C21D 9/00; C22C 38/00

(52) U.S. Cl. CPC C21D 1/40; C21D 9/0068; C22C 38/00; B60N 2/68; B21D 22/022

(57) ABSTRACT

A method of locally heat treating a structural member for a vehicle component, comprising placing the structural member into a fixture including a first element having a first layer that is electrically conductive and a second element having a first layer that is electrically conductive; moving at least one of the first and second elements into contact with the structural member; imparting a pressure into the structural member by at least one of the first and second elements; passing a current through the electrically conductive first layers of the first and second elements to effect at least one heat treated area in the structural member; and stopping the current and releasing the pressure from the structural member.

### CROSS-REFERENCE TO RELATED PATENT APPLICATIONS

This application claims the benefit of and priority to U.S. Provisional Patent Application No. 61/711,041 filed on Oct. 8, 2012, which is incorporated by reference herein in its entirety.

### BACKGROUND

This application relates generally to the field of structures for vehicle seats. More specifically, this application relates to vehicle seat structures having tailored strengths through selective hardening.

### SUMMARY

One embodiment relates to a method of locally heat treating a structural member for a vehicle component. The method includes placing the structural member into a fixture including a first element having a first layer that is electrically conductive and a second element having a first layer that is electrically conductive; moving at least one of the first and second elements into contact with the structural member; imparting a pressure into the structural member by at least one of the first and second elements; passing a current through the electrically conductive first layers of the first and second elements to effect at least one heat treated area in the structural member; and stopping the current and releasing the pressure from the structural member.

The electrically conductive first layers of the first and second elements may be in contact with the structural member when the current is passed through the electrically conductive layers, such that the current also passes into the structural member.

Each of the first and second elements may also include a second layer provided on the electrically conductive first layer, where each second layer is a thermally conductive and electrically insulating layer. The second layers of the first and second elements may be in contact with the structural member, such that current does not pass into the structural member.

Another embodiment relates to a vehicle seat structure that includes a structural member having a heat treated zone including a plurality of heat treated areas, such that the heat treated areas have a microstructure that is different than the microstructure of the non-heat treated areas of the structural member, wherein the plurality of heat treated areas are arranged to provide load path management during loading of the structural member by defining a buckling zone configured adjacent to the heat treated zone.

### BRIEF DESCRIPTION OF THE DRAWINGS

FIG. 1 is a perspective view of a vehicle including an embodiment of the invention.

FIG. 2 is a perspective view of an exemplary embodiment of a seat structure having a structural member with a tailored strength.

FIG. 3 is a side view of an exemplary embodiment of a member of a seat structure having a tailored strength.

FIG. 4 is a perspective view of another exemplary embodiment of a member of a seat structure having a tailored strength.

FIG. 5 is a side view of another exemplary embodiment of a member of a seat structure having a tailored strength.

FIG. 6 is a side view of yet another exemplary embodiment of a member of a seat structure having a tailored strength.

FIG. 7 is a perspective view of a portion of the member of FIG. 4 showing the heat treated zone in the member.

FIG. 8 is a cross-sectional view of the member of FIG. 4 being heat treated locally to tailor its strength.

FIG. 9 is a cross-sectional view of the member of FIG. 3 being heat treated locally to tailor its strength.

FIG. 10 is a schematic diagram showing an exemplary method of heat treating a structural member.

FIG. 11A is a schematic diagram showing a direct resistance system for locally hardening a structure, according to an exemplary embodiment.

FIG. 11B is another schematic diagram showing a direct resistance system for locally hardening a structure, according to another exemplary embodiment.

FIGS. 12A-12E are various views of an assembly configured to heat treat a structural member through indirect resistance, according to an exemplary embodiment.

FIG. 13 is a cross-sectional view of a heating element for use in an indirect resistance assembly, according to an exemplary embodiment.

FIG. 14 is a schematic diagram showing another exemplary method of heat treating a structure using indirect resistance.

FIG. 15 is a schematic diagram showing an indirect resistance system for locally hardening a structure, according to an exemplary embodiment.

FIG. 16 is a perspective view of another exemplary embodiment of a seat member having a structural member with a tailored strength.

FIG. 17 is a perspective view of another exemplary embodiment of a seat member having a structural member with a tailored strength.

FIG. 18 is a perspective view of another exemplary embodiment of a seat structure having a structural member with a tailored strength.

FIG. 19 is a is a perspective view of yet another exemplary embodiment of a seat member having a structural member with a tailored strength.

### DETAILED DESCRIPTION

Referring generally to the Figures, disclosed herein are structural members for use in vehicles, such as in vehicle seat assemblies having tailored strengths through selective hardening. According to an exemplary embodiment, the structural members include one or more than one area that is locally hardened using a method of direct resistance, where a current is passed through the one or more than one area using at least one electrically conductive element in contact with the structural member. According to another exemplary embodiment, the structural members include one or more than one area that is locally hardened using a method of indirect resistance, where a current is passed through at least one electrically conductive element, but is not passed directly through the structural member.

For example, the vehicle seat structures may include a member having a heat treated zone with a plurality of heat treated areas, where the plurality of heat treated areas are arranged to provide load path management (e.g., a controlled buckling zone) during loading of the member. The member may be heat treated in a direct resistance fixture involving, for example, the process steps of placing the member into contact with an electrode, moving a second electrode into contact with the member, imparting a pressure into the member by at least one electrode and passing a current through the electrodes and the member to provide a heat treated area in the member, stopping the current and releasing the pressure from the member, and removing the member from the electrodes. The method of heat treating the member may also include quenching the member, and/or tempering the member. The process may be repeated to provide multiple heat treated areas to form a heat treated zone. Alternatively, multiple heat treated areas may be formed in the member substantially simultaneously, such as in the same fixture.

Also, for example, the vehicle seat structures may include a member having one or more than one heat treated area configured to provide a controlled buckling zone, where the one or more than one heat treated area is provided through indirect resistance. A current may be passed through a heating element including an electrically conductive layer and a thermally conductive and electrically insulating layer that is contacting the member at the heat treated area. The electrically conductive layer may produce heat that is conducted to the heat treated area through the thermally conductive layer.

FIG. 1 illustrates a vehicle 1 having a seat assembly 2 for providing seating to an occupant (not shown) of the vehicle 1. The vehicle 1 is shown as a typical sedan, however, it should be noted that the structural members and seat assemblies disclosed herein may be provided with any type of vehicle, such as, for example, SUVs, vans, trucks, mass-transit vehicles. Accordingly, the examples of vehicles disclosed herein are not limiting.

A seat assembly 2 may include a seat back and a seat bottom, which may be coupled together, such as through a seat mechanism (e.g., recliner) to provide adjustability (e.g., pivoting) of the seat back relative to the seat cushion. The seat assembly 2 may also include a structure or frame that is configured to provide structural support to the seat 2. For example, the seat back may include a back frame, and the seat bottom may include a bottom frame. Each frame may include one structural member (e.g., bracket) or a plurality of interconnected structural members.

The frames (e.g., back frame, bottom frame) may be configured to manage loads that the seat assembly 2 is subjected to, such as, by restraining the seated occupant during a dynamic vehicle impact (e.g., frontal collision, rollover, etc.). For example, the seat assembly 2 may be configured to include an integrated occupant restraint system (e.g., a seat belt assembly) that imparts loading into the frame(s) of the seat induced by restraining the occupant. Since the frame(s) of the seat may be subjected to loading, it may be advantageous to configure the frame(s) for load management, such as where the frame(s) absorbs energy during loading in order to reduce the loads that are transferred to the occupant. For example, the seat assembly 2 may be configured to manage the loading to reduce the likelihood of occupant injury from a dynamic vehicle event by deforming (e.g., plastically) and absorbing loads during deformation. Accordingly, it may be advantageous to tailor the strength of the various structural members of the frame(s) to provide efficient load management. For example, the structural member may include at least one area that has a strength that varies from another area of the member to tailor the strength of the member.

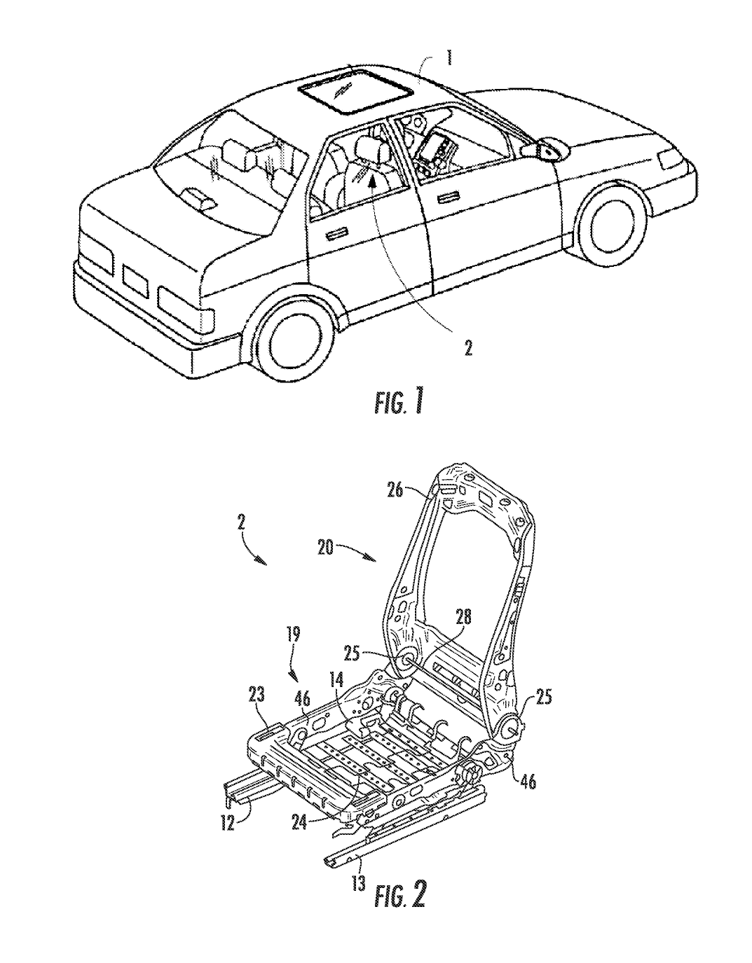

FIG. 2 illustrates an exemplary embodiment of a seat assembly 2 with the foam and trim (e.g., the cushioning and covering) removed for clarity so that the seat structure is visible. The seat structure includes a seat bottom structure 19, a seat back structure 20, a pair of opposing risers 14 slideably coupled to a pair of spaced apart track assemblies 12, 13 (e.g., rails). The seat back structure 20 may be pivotally coupled to the seat bottom structure 19 and/or the risers 14 by a recliner mechanism 25.

The seat bottom structure 19 may include a plurality of structural members that are interconnected through welding, fasteners, and/or any suitable connector. As shown in FIG. 2, the seat bottom structure 19 includes tubular frame 23 and a suspension 24 coupled to the tubular frame 23. The suspension 24 may support the cushioning and the occupant seated on the seat bottom, and the tubular frame 23 is configured to manage the loading through the seat bottom.

The seat back structure 20 may include a plurality of structural members that are interconnected through welding, fasteners, and/or any suitable connector. As shown in FIG. 2, the seat back structure 20 includes a tubular frame 26, a suspension 27 attached to the tubular frame 26, and a cross member 28. The suspension 27 may support the cushioning on the seat back as well as the occupant seated on the seat assembly 2. The tubular frame 26 and the cross member 28 are configured to manage the loading through the seat back.

Each riser 14 may include one or more than one structural member. For example, each riser 14 includes a structural member in the form of a side member 46 that is configured having a tailored strength, such as by using a heat treating process disclosed herein. Additionally, any of the other members that make up the seat back structure 20 and/or the seat bottom structure 19 may be configured having a tailored strength using a heat treating process disclosed herein.

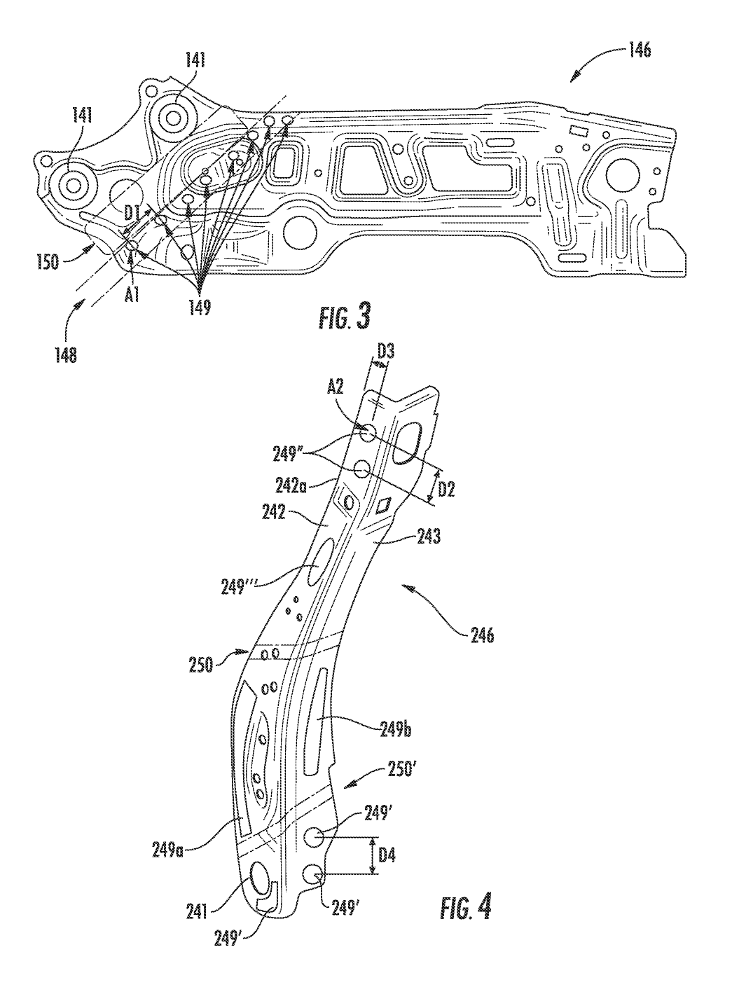

FIGS. 3-6 illustrate various structural members for use in vehicles, such as in vehicle seat assemblies, where the structural members include tailored strengths in local regions through selective hardening the local regions. It is noted that although only a few examples of structural members are disclosed herein, any seat structure component as well as any vehicle structural component may be selectively hardened as disclosed herein in local regions to have tailored strengths, and the examples disclosed herein are not limiting.

FIG. 3 illustrates a structural member in the form of a side member 146 that is configured for use in a seat structure to manage the loading of the seat structure. The side member 146 may be made from steel or any other suitable material that is capable of being heat treated. For example, the side member 146 may be made from a low-strength steel, a high-strength low-alloy steel, boron, a dual phase material, or any other suitable steel. The side member 146 may have any suitable configuration (e.g., shape, size, thickness), such as a generally rectangular elongated configuration. As shown, the side member 146 is in the form a B-bracket having a plurality of raised surfaces (e.g., embosses) with a plurality of openings (e.g., lightening holes), and having a heat treated zone 148 with a plurality of heat treated areas 149 (e.g., locations) provided therein. The plurality of heat treated areas 149 are arranged to provide a heat treated zone 148 that is configured to induce a controlled buckling zone through the side member 146 when under loading in order to manage the loads through the member in a more efficient manner.

According to an exemplary embodiment, the side member 146 includes a predetermined heat treated zone 148 to provide a buckling zone 150 (which is shown in FIG. 3 to be the zone that is enclosed by the phantom lines) below the attachment locations 141 for the back frame (e.g., the recliner) to induce buckling of the back frame while keeping the cushion structure from buckling or buckling less than the back frame. As shown in FIG. 3, the side member 146 includes two spaced apart attachment locations 141 for coupling the back frame to the side member 146, and the buckling zone 150 is configured to extend the width of the side member 146 adjacent to the attachment locations 141. The size (e.g., height, thickness, etc.) of the buckling zone 150 may be tailored depending on the application. According to one example, the size of the buckling zone 150 is between 100-160 mm in length and 10-30 mm in width. The buckling zone 150 is induced by the heat treated zone 148 that is provided adjacent (e.g., below) to the buckling zone 150.

As shown, the heat treated zone 148 includes eight heat treated areas 149, where each pair of adjacent heat treated areas 149 are spaced apart by a spacing distance D1. According to one example, the spacing distance D1 is between 8-20 mm, and more preferably, the spacing distance D1 is about 14 mm. Each of the heat treated areas 149 disposed at the ends may be spaced from an adjacent edge (e.g., periphery) of the side member 146 by a distance equal to the spacing distance D1 or another distance. Thus, the spacing distance between the pairs of heat treated areas may be generally the same or may be different compared to one another.

The size (e.g., radius, diameter, area) of each heat treated area 149 may be configured similar to or different than other heat treated areas. The size of each heat treated area 149 may also be tailored based on the application. According to one example, each heat treated area 149 has a diameter A1 of between 2 and 10 mm and more preferably, the diameter A1 of each heat treated area 149 is about 6 mm.

According to an exemplary embodiment, the plurality of heat treated areas 149 of the side member 146 are provided using a direct resistance process, such as the process described below. The plurality of heat treated areas 149 may be provided simultaneously, such as by direct resistance welding the plurality of heat treated areas 149 at the same time by a plurality of fixtures, where each fixture includes a pair of opposing electrodes configured to treat one area 149. Alternatively, the plurality of heat treated areas 149 may be provided at different times, such as, for example, sequentially, using a single fixture having a pair of electrodes. According to another exemplary embodiment, the heat treated areas 149 of the side member 146 are provided using an indirect resistance process.

FIG. 4 illustrates another exemplary embodiment of a structural member in the form of a back frame member 246 that is configured to manage the loading through a seat back structure, such as for the seat assembly 2. The back frame member 246 includes at least one heat treated area 249. As shown, the back frame member 246 includes a plurality of heat treated areas 249 having a combination of similar and dissimilar shapes. However, the back frame member 246 may be configured having only similar or dissimilar shapes. The general shape of the heat treated area may be influenced by the shape of the electrodes. For example, generally cylindrical shaped electrodes may form a generally cylindrical shaped heat treated area 249. Also, for example, the electrodes may be configured having other shapes, such as generally oval shaped, ellipse shaped, or any suitable shape. These other shaped electrodes may produce heat treated areas having shapes similar to the electrodes.

The back frame member 246 may include a plurality of heat treated areas 249 to provide at least one buckling zone. According to an exemplary embodiment, the back frame member 246 includes a first buckling zone 250 provided generally about mid-height from an attachment location 241 for a lower structure (e.g., a cushion structure, a side member, etc.). For example, the first buckling zone 250 may be configured to be near an h-point of a seated occupant, such as between the h-point and the middle back portion of the seated occupant. According to one example, the buckling zone 250 has a length that is between 75-125 mm and a width that is between 8-16 mm. More preferably, the buckling zone may have a length that is about 100 mm and a width that is about 12 mm.

The back frame member 246 may include an elongated first heat treated area 249a provided on a first side 242 of the back frame member 246. The first side 242 may extend in a fore and aft plane (in vehicle), as opposed to a cross-car plane, such that the first heat treated area 249a extends in the fore and aft plane as well. For example, the first heat treated area 249a may be configured to extend vertically in the fore and aft plane. The first heat treated area 249a may extend from the attachment location 241 (or near the attachment location 241) to about the mid-height of the back frame member 246. According to one example, the elongated first heat treated area 249a has a length that is between 150-250 mm, and more preferably, the length is about 200 mm. Also, according to one example, the first heat treated area 249a has a width that is between 10-20 mm, and more preferably, the width is about 15 mm.

The back frame member 246 may also include an elongated second heat treated area 249b provided on a second side 243 of the back frame member 246. The second side 243 may extend in a cross-car plane (in vehicle), which may be configured transverse to the fore and aft plane, such that the second heat treated area 249b extends in the cross-car plane as well. The second heat treated area 249b may be configured generally adjacent to the first heat treated area 249a, and may extend a length from about the mid-height of the back frame member 246, where the length may be similar to or different than the length of the first heat treated area 249a. According to one example, the second heat treated area 249b has a length that is between 50-150 mm, and more preferably, the length is 100 mm. Also, according to one example, the second heat treated area 249b has a width that is between 8-16 mm, and more preferably, the width is about 12 mm.

Also shown in FIG. 4, the back frame member 246 may be configured to include a second buckling zone 250′, either alone or in combination with other buckling zone(s) disclosed herein. The second buckling zone 250′ may be provided above and proximate to the attachment location 241, such as to drive buckling of the back frame member 246 just above the attachment of the recliner and/or the lower structure. According to one example, the second buckling zone 250′ has a length that is between 120-170 mm and a width that is between 8-16 mm. More preferably, the buckling zone may have a length that is about 145 mm and a width that is about 12 mm.

To influence the back frame member 246 to buckle along the second buckling zone 250′, the back frame member 246 may be configured having at least one heat treated area provided adjacent to the second buckling zone 250′. For example, the back frame member 246 may include three heat treated areas 249′, where one heat treated area 249′ is provided below the attachment location 241 on the first side 242 of the back frame member 246 and where two heat treated areas 249′ are provided adjacent to the attachment location 241 on the second side 243 of the back frame member 246. According to one example, each of the heat treated areas 249′ may have an area that is between 3-79 mm², and more preferably, the area is about 28 mm². The heat treated areas 249′ may be spaced apart by a distance D4. According to one example, the spacing distance D4 is between 20-30 mm, and more preferably, the spacing distance D4 is about 25 mm. It is noted that two or more of the heat treated areas 249′ (e.g., the two areas provided on the second side 243) can be made into a unitary heat treated area.

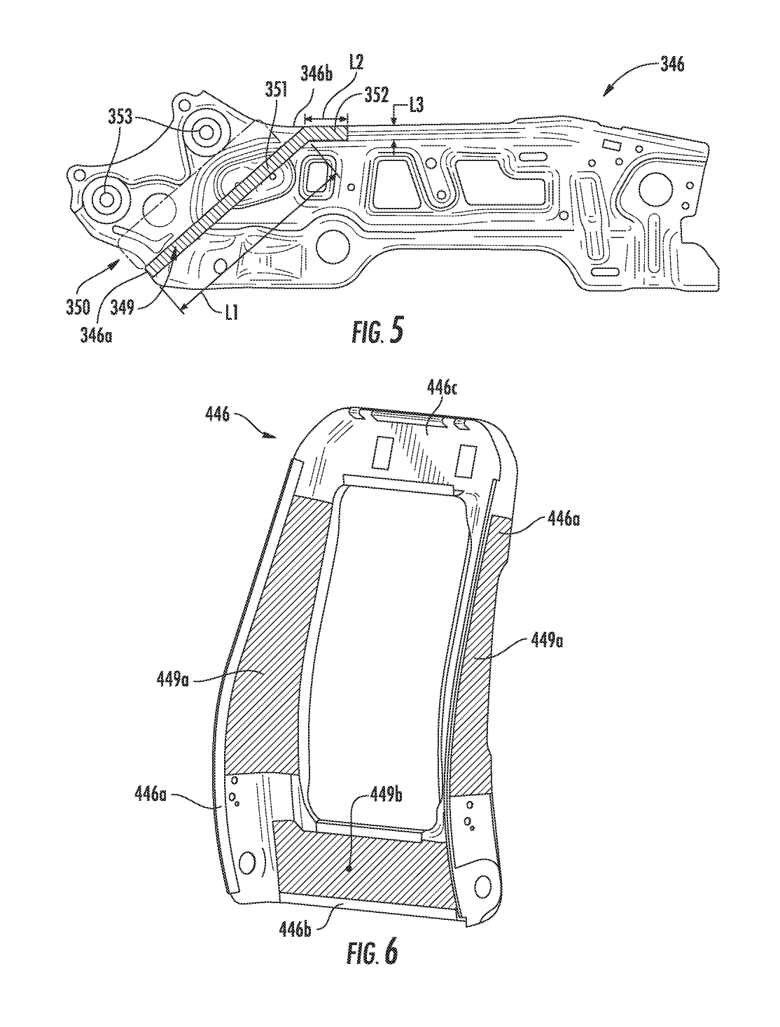

The back frame member 246 may be configured to include other buckling zones, which may be influenced by other heat treated areas. Further, the back frame member 246 may include other heat treated areas to locally reinforce a portion of the back frame member 246, such as to prevent the portion from buckling. For example, the back frame member 246 may be configured to be coupled to an upper member (e.g., upper member 446c shown in FIG. 6), where the upper member is configured to support a head rest. The head rest may impart a relative high loading through the back frame, such as during a rear vehicle impact event. The back frame member 246 may include one or more than one heat treated area to increase the strength of the back frame member local to the location where the upper member is coupled to the back frame member in order to prevent buckling from the loading imparted by the head rest.

According to the example shown in FIG. 4, the back frame member 246 includes a pair of circular shaped heat treated areas 249″ provided on an upper portion of the first side 242 where the upper member is configured to be coupled to the back frame member 246. According to one example, the heat treated areas 249″ are spaced apart by a spacing distance D2 of between 20-30 mm, and more preferably, the spacing distance D2 is about 25 mm. According to one example, each heat treated area 249″ is located from a front edge 242a (e.g., a periphery) of the first side 242 by the spacing distance D3 of between 10-20 mm, and more preferably, the spacing distance D3 is about 15 mm. Also, according to one example, each heat treated area 249″ may have a diameter A2 of between 2-10 mm, and more preferably, the diameter A2 is about 6 mm.

This arrangement may advantageously prevent buckling of the upper portion of the back frame member 246 and drive buckling to the buckling zone 250. For example, this arrangement may withstand the loading from the occupant and drive the loading, such as from the head rest and/or the upper member, down to the buckling zone 250 to facilitate buckling in the buckling zone 250.

The back frame member 246 may optionally include an elongated heat treated area 249′ provided below the pair of circular shaped heat treated areas 249″, which may be located below where the upper member is coupled to the back frame member 246, to carry the loads from the head rest and upper member to the buckling zone 250. According to one example, the heat treated area 249′ has an area of between 490-970 mm², and more preferably, the area is about 730 mm².

According to an exemplary embodiment, the plurality of heat treated areas 249 of the back frame member 246 are provided using a direct resistance process, such as the process described below. According to another exemplary embodiment, the plurality of heat treated areas 249 of the back frame member 246 are provided using an indirect resistance process, such as the process described below. According to yet another exemplary embodiment, the plurality of heat treated areas 249 may be provided by a combination of direct and indirect resistance processes.

FIG. 5 illustrates a structural member in the form of a side member 346 that is configured having basically the same configuration (e.g., shape, size, thickness) as the side member 146, except the side member 346 includes a single heat treated area 349 that extends over a relatively larger area, as opposed to a plurality of heat treated areas 149 having relatively smaller areas that extend over a heat treated zone. In other words, the side member 346 has a single heat treated area 349, which may be configured having an area that is larger than the sum of the areas of the plurality of heat treated areas 149 of the side member 146.

The single heat treated area 349 of the side member 346 is configured to induce plastic deformation (e.g., controlled buckling) through a zone, such as the controlled buckling zone 350 of the side member 346 (shown in FIG. 5 using phantom lines) when under loading in order to manage the loads through the member in a more efficient manner. For example, the side member 346 may include a buckling zone 350 near the attachment locations 353 for the back frame (e.g., the recliner) to induce buckling of the back frame while keeping the cushion structure from buckling or buckling less than the back frame when the seat structure is being loaded, such as during occupant loading.

As shown, the heat treated area 349 includes a first portion 351 and a second portion 352 extending away from the first portion 351 at an angle. The first portion 351 may have a generally rectangular shape and may extend across a first section of the side member 346. As shown in FIG. 5, the first portion 351 extends from a first periphery 346a of the side member 346 to a second periphery 346b having a length L1. The first portion 351 may also have a width that is equal to the length L3. According to one example, the length L1 of the first portion 351 is between 105-155 mm and the width L3 is between 8-16 mm. More preferably, the length L1 is about 130 mm and the width L3 is about 12 mm. The first portion 351 may be located at a distance of between 50 and 100 mm from the attachment locations 353 (e.g., the approximate centers thereof).

The second portion 352 of the heat treated area 349 may have a generally rectangular shape and may extend across a second section of the side member 346. As shown in FIG. 5, the second portion 352 extends from an end of the first portion 351 along the second periphery 346b of the side member 346 a length L2 and has a width L3. According to one example, the length L2 of the second portion 352 is between 25-75 mm and the width L3 is between 8-16 mm. More preferably, the length L2 is about 50 mm and the width L3 is about 12 mm. It is noted that the heat treated area 349 may be configured to have a different configuration (e.g., shape, size, etc.) from the example disclosed herein. In other words, the configuration of the heat treated area 349 is disclosed as an example and is not limiting.

According to an exemplary embodiment, the heat treated area 349 of the side member 346 is provided using an indirect resistance process, such as the process described below. The process may heat treat the entire area of the heat treated area 349 at substantially the same time. In other words, the first and second portions 351, 352 may be heat treated at the same time or at different times, such as in different heat treat operations.

FIG. 6 illustrates another exemplary embodiment of a structural member in the form of a back frame 446 that is configured to manage the loading through the seat back of the seat assembly, such as the seat assembly 2. The back frame 446 includes a pair of side members 446a that are interconnected by a lower member 446b and an upper member 446c. The back frame 446 includes at least one heat treated area, which may be treated using a direct resistance process or an indirect resistance process. As shown, the back frame 446 includes a plurality of heat treated areas, including a heat treated area 449a on each side member 446a and a heat treated area 449b on the lower member 446b. The general shape of the heat treated areas may be tailored to influence the load carrying characteristics of the back frame 446, such as to provide load management, and the areas may be configured differently than what is shown in FIG. 6.

According to one example, each heat treated area 449a has an area that is between 20,000-40,000 mm². In other words, each side member 446a has a heat treated area 449a having a size of between 20,000-40,000 mm². More preferably, the size of each heat treated area 449a is about 30,000 mm². Also, according to one example, the heat treated area 449b of the lower member 446b has an area that is between 30,000-60,000 mm². More preferably, the size of the heat treated area 449b is about 45,100 mm².

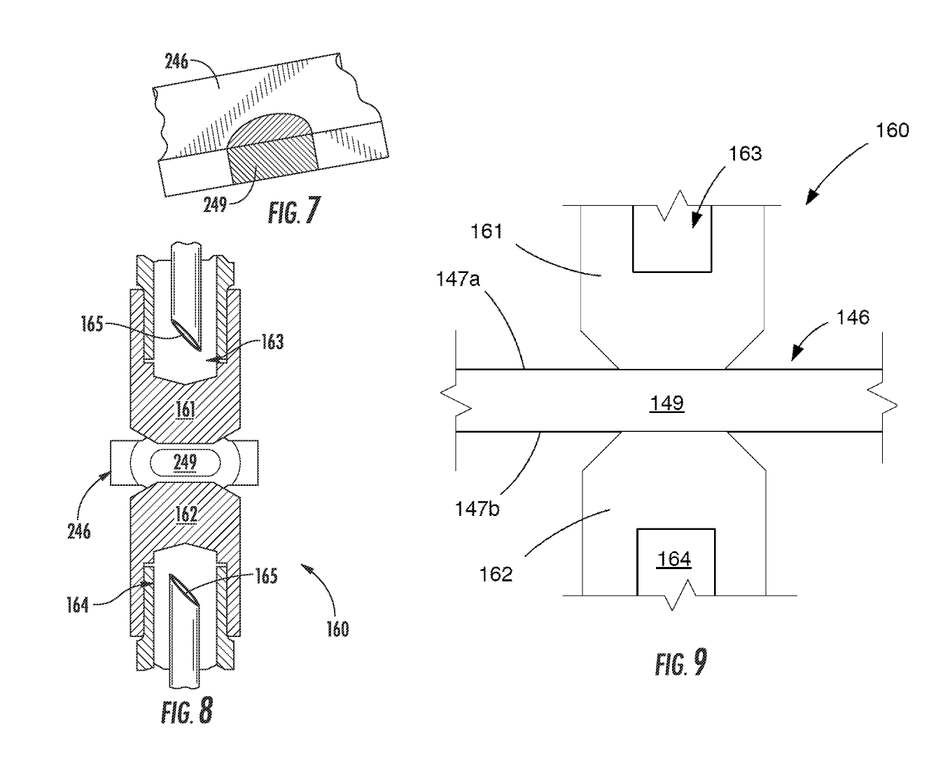

FIGS. 8 and 9 illustrate an exemplary example of a direct resistance assembly configured to heat treat a structural member to provide a heat treated area. FIG. 8 illustrates the back frame member 246 being heat treated by the direct resistance assembly 160 to form the heat treated area 249 shown in FIG. 7. As shown in FIG. 7, the heat treat area 249 may be configured to extend through the entire thickness of the back frame member 246. FIG. 9 illustrates the structural side member 146 being heat treated by the direct resistance assembly 160 to form the heat treated area 149. The process involves heat treating the structural member (e.g., the side member 146, the back frame member 246) using a fixture in the form of the direct resistance assembly 160.

According to an exemplary embodiment, the direct resistance assembly 160 may be configured similar to a spot welding assembly. As shown in FIGS. 8 and 9, the direct resistance assembly 160 includes a first electrode 161 (e.g., an upper electrode) and a second electrode 162 (e.g., a lower electrode) that opposes the first electrode 161. The first and second electrodes 161, 162 are configured to conduct electricity and made from an electrically conductive material (e.g., brass, copper, etc.). The direct resistance assembly 160 includes a power supply (not shown in FIG. 8 or 9) that is configured to provide the electric power that is passed to the first and second electrodes 161, 162. The electric power may be routed to the electrodes using wiring or any suitable device. Each electrode (e.g., electrode 161, 162) may include a cavity (e.g., a cavity 163, 164) provided therein for receiving a fluid (e.g., water) to regulate (e.g., control) the temperature (e.g., cool) of the electrode during the welding process. As shown in FIG. 8, each cavity 163, 164 includes a fluid dispenser 165 that is configured to introduce a coolant into the cavity to regulate the temperature of the electrode. The fluid dispenser 165 may be in fluid communication with a conduit or other element capable of transferring the fluid to the fluid dispenser 165.

The assembly 160 is configured to move between positions, such as an open position and a closed position. In the open assembly position, the first and second electrodes 161, 162 are configured in a first position (e.g., an open position) where the electrodes are spaced apart by a first distance, which allows for the work piece (e.g., the side member 146, the back frame member 246) to be placed between the two electrodes. One electrode (e.g., the first electrode 161) or both electrodes may be configured to move in a direction toward the opposing electrode to reduce the first distance to a second distance with the electrodes in a second position (e.g., a closed position). In the second position, the electrodes 161, 162 come into contact with the work piece to thereby pass the electric power (e.g., current) through the work piece. FIGS. 8 and 9 show the first and second electrodes 161, 162 in the second position where each electrode is contacting an opposing side (e.g., surface) of the respective side member 146, 246. For example, the first electrode 161 contacts the first side 147a (e.g., upper side) of the side member 146, and the second electrode 162 contacts the second side 147b (e.g., lower side) of the side member 146.

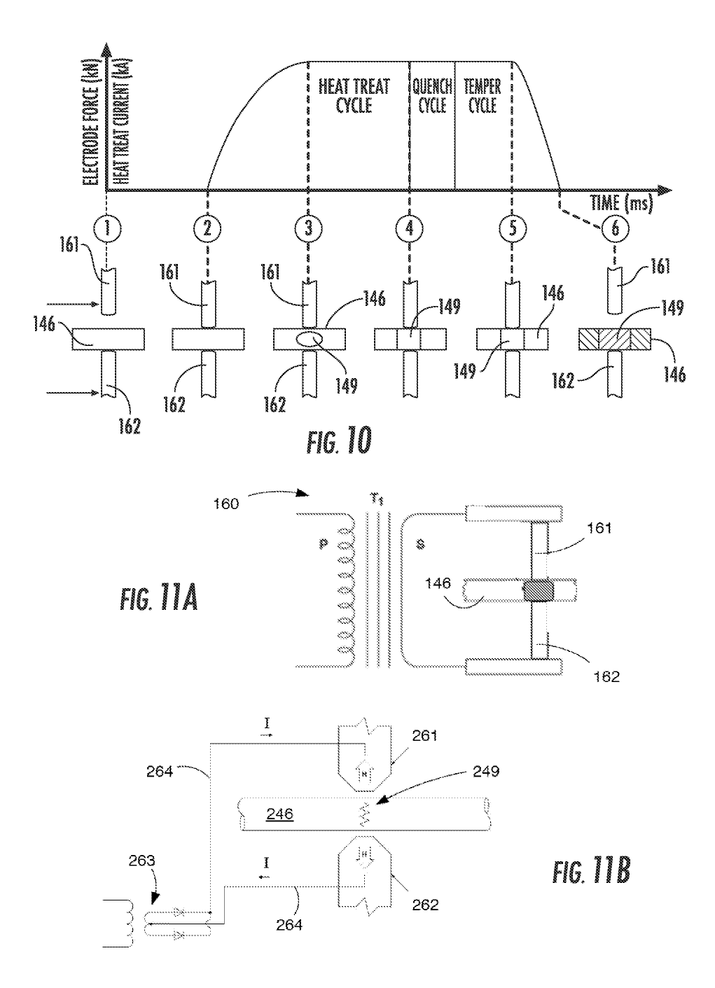

FIG. 10 illustrates a schematic drawing showing an exemplary method of heat treating a side member 146, such as to form one or more heat treated areas 149, using a direct resistance process. The process is configured to modify the microstructure of the heat treated areas 149 to be different than the microstructure of the remaining portions (e.g., the non-heat treated areas) of the side member 146. The thermal cycle of the direct resistance method or process is relatively quick, and may form a martensitic microstructure in the heat treated area 149 of the side member 146 in less than one second. FIG. 10 also shows the electrode force and current over time for the direct resistance heat treating cycle. According to an exemplary embodiment, the direct resistance heat treating process involves a three step method.

In a first step of the process, the side member 146 is placed into contact with the second (e.g., lower) electrode 162 when the first (e.g., upper) electrode 161 is in an open or raised position. Accordingly, there is zero pressure and zero current imparted to the side member 146.

In a second step of the process, the first electrode 161 is moved downwardly into contact with the side member 146. In other words, the first electrode 161 is moved from the open position to the closed position. Once both electrodes are in contact with the side member 146, then additional movement of one of the electrodes (e.g., the first electrode 161) induces pressure into the side member 146. Further, once both electrodes are in contact, the electric power is able to pass through the side member 146 from the electrodes to induce the heat treatment of the side member 146.

In the third step of the process, the first electrode 161 is moved farther down relative to the second electrode 162 to increase the pressure on the side member 146. During the third step, a level of current is passed through a heat treated area 149 of the side member 146 to increase the temperature of the side member 146 to induce a heat treatment of the side member 146. For example, the temperature of the material of the side member 146 proximate the electrodes may be raised or elevated to a temperature above the lower critical temperature, such as to approximately 910° C. (1670° F.) in a first time to convert the steel to austenite, as shown in FIG. 7. The first time in which the temperature of the side member 146 is raised may preferably be very short, such as, for example, in milliseconds.

According to other exemplary embodiments, the heat treating process may involve a fourth step, a fifth step, and/or a sixth step. In the fourth step of the process, the heat treated area of the side member 146 is rapidly cooled from austenite to form a martensitic and/or bainitic microstructure in a quench cycle. The quench cycle may be done external to the fixture or may be done in the fixture, using any suitable quench fluid (e.g., air, water, oil, etc.). The parameters of the quench cycle (e.g., fluid, time, etc.) may be varied in order to tailor the microstructure of the heat treated area of the side member 146.

In the fifth step of the process, the side member 146 may be tempered or annealed. For example, the heat treated area of the side member 146 may be tempered by heating the heat treated area (e.g., the heat treated area 149, 249) to a temperature (e.g., a temperature below the lower critical temperature). The side member 146 may be tempered to increase the toughness of the side member 146, since heat treating may increase the brittleness as well as the strength of the side member 146.

In the sixth step of the process, the first electrode 161 is moved upwardly from the closed position to the open position to allow for the side member 146 to be moved or removed from the fixture. For example, the side member 146 may be moved in order to form another heat treated area. Also, for example, the side member 146 may be removed from the fixture if all of the heat treated area(s) are formed.

FIG. 11A illustrates a schematic diagram showing an exemplary embodiment of a direct resistance assembly 160 (e.g., welding assembly) for locally hardening a structure or member (e.g., the side member 146, the back frame member 246). The direct resistance assembly 160 is configured to pass a current (e.g., a single pulse of current) through a work piece via the electrically conductive electrodes 161, 162. The direct resistance assembly 160 may be used with the exemplary process discussed above or any suitable process. The direct resistance assembly 160 may include a power source or supply. The direct resistance assembly 160 may also include a transformer T1 that is configured to transfer energy, such as by inductive coupling. For example, the transformer T1 may include a primary circuit P and a secondary circuit S, where electrical power is transferred (e.g., transmitted, delivered) from the primary circuit P to the secondary circuit S. The secondary circuit S may be in electrical connection with the electrodes 161, 162.

FIG. 11B illustrates another schematic diagram of another direct resistance assembly 260 including a first electrode 261 and a second electrode 262, which are in electrical connection with a power supply 263. The power supply 263 is configured to produce a current I, which passes to the electrodes 261, 262 through electrical connections 264 and through a work piece in the form of the back frame member 246 to locally heat treat the area 249. It is noted that the direct resistance assembly may be configured differently than disclosed herein, and in particular the power supply device and/or the electrical connections may be configured differently.

According to an actual test sample of a structural member having a heat treated area that, for example, is approximately seven millimeters (7 mm) in diameter, the heat treated area of the member has a hardness of 50 HRC following heat treatment and the portion of the member surrounding the heat treat area has a hardness of 70 HRB. The heat treating conditions for providing the heat treat area on the test sample involved a nine-hundred pound-force (900 lbf) from the electrodes and a single pulse current was provided over a time period of twenty-eight milliseconds (28 ms). The test sample did not involve a quench following the heat treatment. It is noted that these parameters and dimensions are not limiting and are intended to illustrate a single example.

According to another actual test sample configured as a coupon (e.g., tensile test specimen) including triangular shaped notches provided on both sides of the locally heat treated area, the failure mode during tensile testing was controlled to be outside of the heat treated area. The notches were configured to control the failure location of the sample during testing, and the failure location moved to outside of the heat treated zone, such as, bypassing the heat treated (e.g., hardened) area and instead following the surrounding radial heat affected zone. Thus, the test samples show that the load (e.g., failure) can be directed and controlled by the local heat treating.

The inventors of this application found that direct resistance process was effective for locally heat treating relatively small areas (e.g., areas equal to or less than about 7 mm) of structural components, such as for seat assemblies, but that the direct resistance process was less effective at heat treating relatively larger areas (e.g., areas greater than about 7 mm) of the structural components. For example, in order to increase the size of the heat treated area, the size of the electrode must increase accordingly. However, it was found that as the size (e.g., diameter) of the electrode increases, the size of the work piece that was effectively heat treated had a diminishing return, because the current through the electrode has a tendency to accumulate in the outer portions (e.g., periphery) of the electrode. Accordingly, the direct resistance process effectively heat treats the outer portions of the effected area, but the inner portion is less effectively treated, and in particular for larger areas. Therefore, for an electrode having a circular cross-section, the electrode having a relatively larger size (e.g., greater than about 7 mm in diameter) produces an effective heat treated area that is annular shaped where the center portion may not be effectively heat treated. As the size of the electrode increases, the size of the center portion increases providing a larger portion which is heat treated to a lesser degree than the outer portion.

Thus, it was found that passing a current directly through the work piece (i.e., using direct resistance process to heat treat) limited the area that could be heat treated effectively. Accordingly, the inventors of this application sought to overcome this limitation of the direct resistance process, and surprisingly discovered that by passing the current directly through a heating element that was electrically insulated from the work piece yet provided adjacent to the work piece, the size (e.g., area) of the work piece that is heat treated increases without the drawbacks found in the direct resistance process.

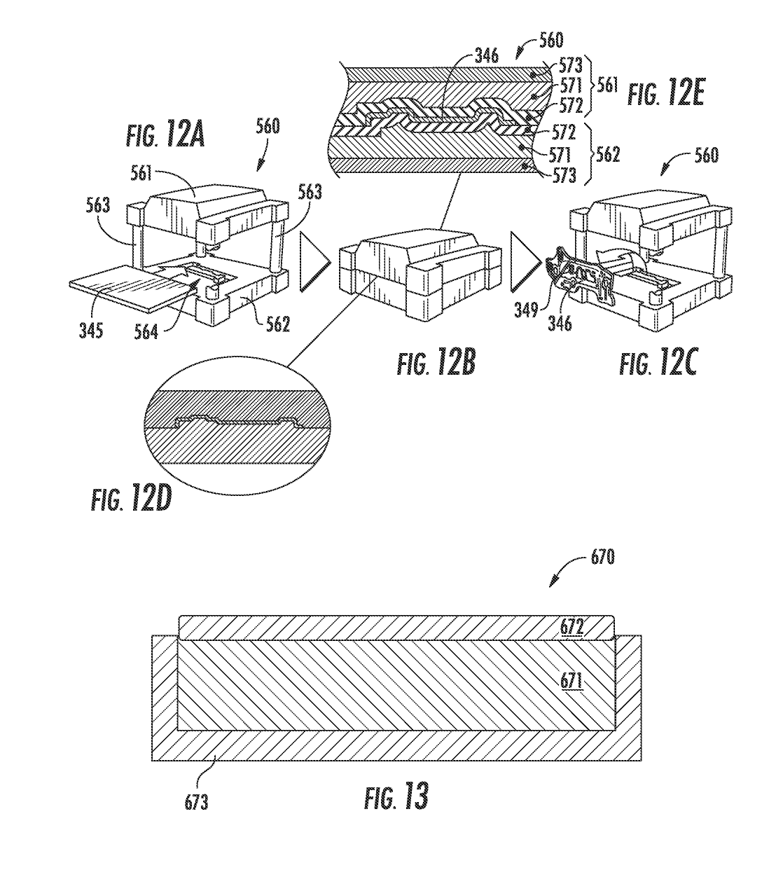

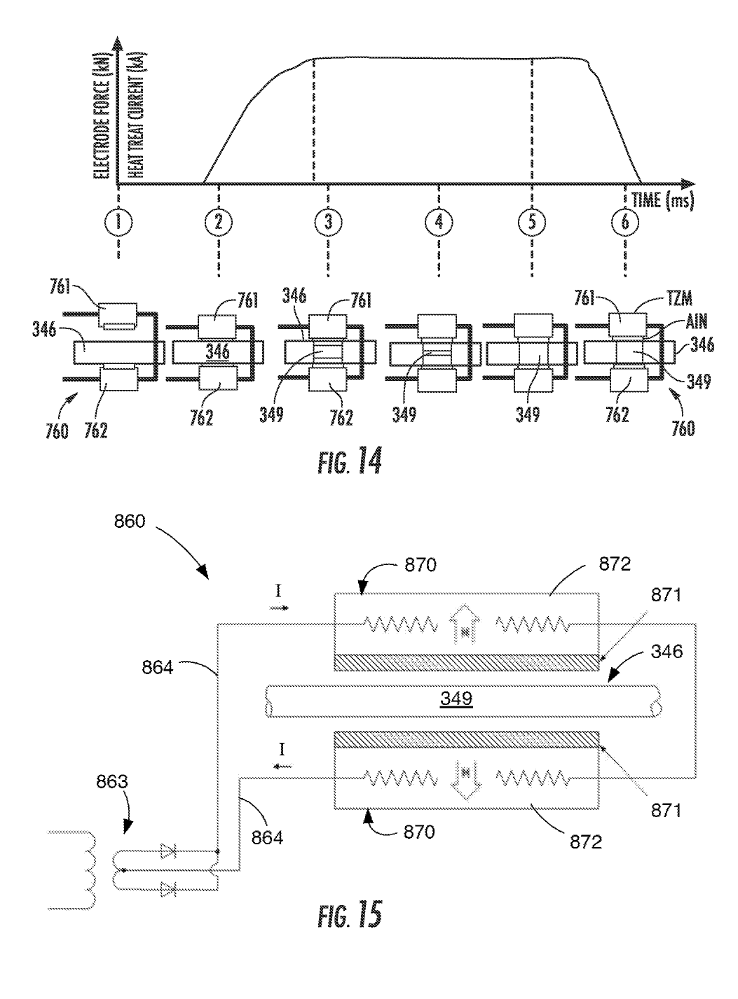

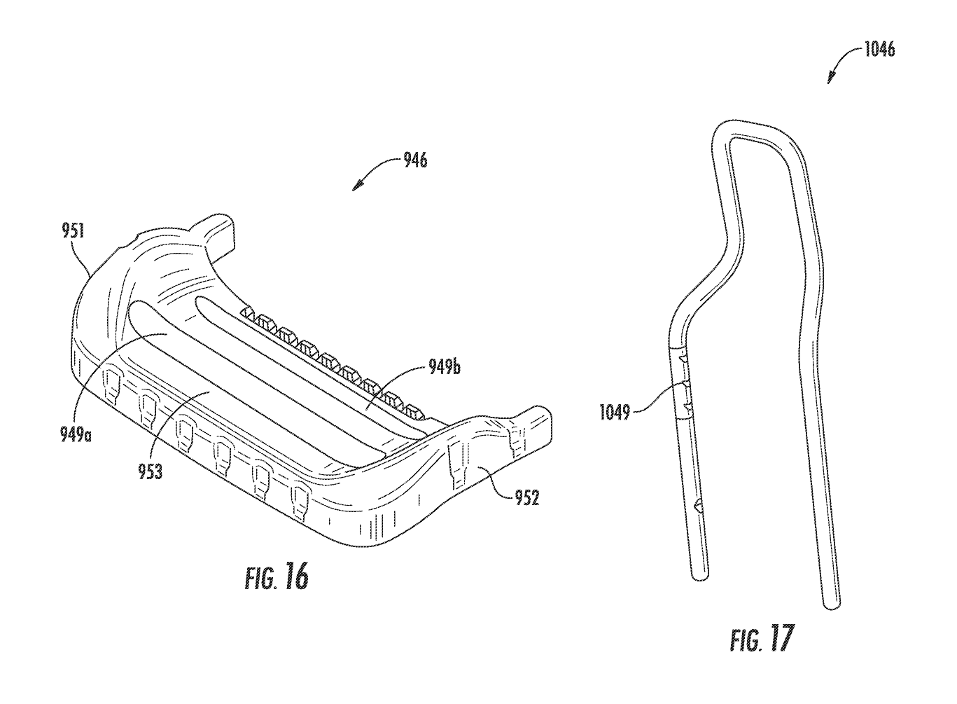

FIGS. 12A-12E are various views of an exemplary embodiment of an assembly 560 (e.g., an indirect resistance assembly, resistance welder, fixture, etc.) configured to locally heat treat predetermined areas or locations of a structure (e.g., a structural member) by using an indirect resistance process or method. As shown in FIG. 12A, the assembly 560 includes a first die half 561, a second die half 562, and guide elements 563 that are configured to properly align the first and second die halves 561, 562. At least one of the die halves 561, 562 is configured to move to switch the assembly 560 between an open position (as shown in FIGS. 12A and 12C) and a closed position (as shown in FIG. 12B). A cavity 564 is provided between the first and second die halves 561, 562 to receive a member, such as a sheet member or a blank 345 therein. The cavity 564 may be defined by one of or both of the die halves 561, 562 of the assembly 560.

At least one die half 561, 562 is configured with an element (e.g., an electrically conductive heating element) that is configured to produce heat upon passing an electric current (or voltage) through the element. The assembly 560 may be configured to be a direct resistance system where the electrically conductive heating element is in direct contact with the work piece (e.g., the blank 345, the side member 346, etc.). For example, both die halves 561, 562 may be configured having an electrically conductive heating element that may be positioned in direct contact with work piece.

According to the exemplary embodiment shown in FIG. 12E, the assembly 560 is configured as an indirect resistance system where each die half 561, 562 includes a first layer 571 and a second layer 572 that is disposed on an inside of the first layer 571. The first layer 571 is configured as an electrically conductive heating element, and the second layer is configured as an electrically insulating and thermally conductive element. The second layer 572 is configured to be disposed between the work piece (e.g., the blank 345, the side member 346, etc.) and the first layer 571 to transfer the heat generated by the first layer 571 to the work piece while prohibiting the electric current from passing through the work piece. Preferably, the first and second layers 5571, 572 are in direct contact to facilitate the transfer of heat, such as through conduction. During heat treating of the work piece, the second layer 572 of each die half 561, 562 may be in direct contact with the work piece, while the first layer 571 of each die half does not contact the work piece.

Each die half 561, 562 may optionally include additional layers. As shown in FIG. 12E, each die half 561, 562 includes an optional third layer 573 that is disposed on an outside of the first layer 571. The third layer 573 may be configured to surround the portions of the first layer 571 that are not contacting the second layer 572. The third layer 573 may be made out of an electrically conductive material that has relatively high corrosion resistance. The third layer 573 may surround one or more than one of the surfaces of the second layer to prohibit corrosion of the surfaces of the second layer 572.

According to an exemplary embodiment, the assembly 560 is configured as a combined press and indirect resistance assembly to form the structural member and locally heat treat a portion of the structure, which may occur substantially simultaneously. For example, the assembly 560 may be configured as a tool in the form of a stamping die that forms the blank 345 (e.g., a sheet of a metal, such as steel) into a formed component, such as the side member 346, the back frame member 446, or any other suitable structural member. In other words, the assembly 560 is configured to form geometric features (e.g., ribs, embosses, flanges, holes, openings, etc.) in the member. The tool may be in the form a progressive die, a transfer die, a feinblanking die, or any suitable process for forming a member, such as a structural member. The assembly 560 may also include an element, such as a heating element that is located in the tool or die that is configured to locally heat treat a portion of the formed component, such as the heat treated area 349 of the side member 346, through either direct or indirect resistance.

As shown in FIG. 12A, when the assembly 560 is in the open position, the blank 345 of material may be placed into a cavity 564 formed between the first and second die halves 561, 562 of the assembly 560. As shown in FIG. 12B, the assembly 560 may close over the blank 345, such as through movement of one or both of the die halves 561, 562, forming it into the side member 346, such as through pressure.

When in the closed position, the assembly 560 configured as an indirect resistance assembly is configured to locally heat treat one or more than one portion of the blank 345 and/or the structural member (e.g., the side member 346) that is placed adjacent to a thermally conductive element of the assembly 560. As shown in FIG. 12E, each die half 561, 562 of the assembly 560 may be configured to locally heat treat a surface or an area (e.g., portion) of the surface of the side member 346, such as the heat treated area 349 shown in FIG. 12C. In other words, the assembly 560 may be configured to heat treat two different surfaces of the work piece simultaneously. The size of the heating elements of the die halves may be varied for different applications in order to tailor the size of the effective heat treated area to the specific structure and/or vehicle. For example, the size of the heating elements may be the same size or any size less than the size of the die halves.

As shown in FIG. 12C, once the assembly 560 has heat treated and/or formed the component (e.g., the side member 346), then the assembly 560 moves to the open position, where the component may be removed, either manually or automatically. Although the assembly 560 is shown as a single operation assembly, such as a transfer die, the assembly 560 may be configured as a multiple operation assembly, such as a progressive die. The multiple operation assembly may include two or more operations that are configured to form the part, such as in successive operations. The multiple operation assembly may include heating elements in one operation or in any number of the operations that form the component. Thus, the multiple operation assembly may be configured to provide multiple heat treated areas, which may be configured having different levels (e.g., degrees) of heat treating. Therefore, a structural member may be configured to include a first heat treated area having a first property (e.g., strength, hardness, etc.) and a second heat treated area having a second property that may be configured differently than the first property of the first heat treated area. For example, the first portion 351 of the side member 346 may be heat treated to a first property formed by a first operation, and the second portion 352 of the side member 346 may be heat treated to a second property formed by a second operation.

The assembly 560 may be configured to include a cooling device or system to regulate the temperature of the assembly 560. The assembly 560 may include utilize a coolant that is passed directly or indirectly over a portion of the assembly 560. For example, the assembly 560 including the third layer 573 may be configured having a coolant that is directly passed over the third layer 573 to influence (e.g., control) the temperature of the third layer 573.

According to an exemplary embodiment of an indirect heating assembly, the indirect heating process includes pressing at least one heating element directly against the work piece (e.g., the member, the component, etc.), such that the at least one heating element contacts the work piece. The indirect heating assembly may be configured to exert or apply a force (e.g., pressure) on the work piece to provide sufficient contact to ensure efficient heat transfer from the at least one heating element to the work piece. According to one example, a pneumatic cylinder may be used to apply a force of between 4450 N and 31,125 N to the work piece. According to another example, the indirect heating assembly may apply a force of at least 6000 N onto the work piece. It is noted that another device, such as a hydraulic cylinder, may be used to apply the force.

During contact between the heating element(s) and the work piece, a current generated by a power supply may be passed through the heating element(s) to generate the heat used to treat the work piece (i.e., heat treat the at least one heat treated area). According to one example, the power supply produces a current of about 75,000 A for a time of up to 800 milliseconds. A current density of about 83 A/mm² may be used during the heat generating process. The process may be tailored to provide a desired threshold temperature (e.g., a heating temperature). For example, a heating of temperature of at least 1250° C. may be used as the threshold heating temperature. The process may utilize different devices (e.g., equipment) for the power supply. One such non-limiting example of the equipment includes a 2000 A inverter based MFDC power supply and 400 KVA transformer.

After terminating current flow through the heating element(s), the system (e.g., heating assembly, work piece, etc.) is allowed to cool. Cooling may be accomplished by several methods, including, but not limited to continued contact with the elements (e.g., conduction) or through the use of a cooling fluid. For example, the heated treated areas in the work piece may be rapidly cooled by diffusion of heat through the thermally conductive coating/heating elements and into the heating assembly. The heating assembly may be water cooled, such as through copper blocks or members of the heating assembly that are configured to include cooling channels or conduits for the water to pass into or through. The heating assembly may also be air cooled, such as through convection by passing the air across the work piece and/or the heating assembly.

The indirect heat treating may be accomplished by the generation of Joule-based heat within one or more separate and discrete heating elements (e.g., TZM heating elements). The process uses the high electrical resistivity of the heating elements interacting with the high current applied by a power supply of the heating assembly to provide sufficient heat time to produce metallurgical transformations in the work piece.

FIG. 13 is a cross-sectional view of a heating element 670 for use in an indirect resistance welding assembly, such as the assembly 560. The heating element 670 be a multi-layered element. For example, the heating element 670 may be configured as a bi-layered (e.g., a laminate) element, including a first layer 671 of electrically conductive material with a second layer 672 of thermally conductive and electrically insulating material disposed adjacent to a portion (e.g., an inside surface) of the first layer 671.

As shown in FIG. 13, the heating element 670 includes a first layer 671, a second layer 672 provided on a first surface of the first layer 671, and a third layer 673 provided on a second surface of the first layer 671. The second layer 672 may be provided on the first layer 671, such that a surface (e.g., an upper surface, an inner surface, etc.) of the first layer 671 is in contact with (e.g., abuts) a surface (e.g., a lower surface, an outer surface, etc.) of the second layer 672. The third layer 673 may be configured to surround the surfaces of the first layer 671 that the second layer 672 is not disposed on. Also, for example, the third layer 673 may be configured to surround a portion of the second layer 672, such as other than the surface of the second layer 672 that is adjacent to or abutting the first layer 671.

The first layer 671 of the heating element 670 may be made out of an electrically conductive material, and preferably out of a material that reacts to current flow by generating heat. According to one example, the second layer 672 is made from TZM molybdenum having a composition of about 0.50% titanium, 0.08% zirconium, 0.02% carbon, and with the remaining balance molybdenum. It is noted that the first layer 671 may be made out of another suitable electrically conductive materials, and that TZM molybdenum is not limiting. Additionally, the heat generated in the first layer 671 can be input into the work piece (e.g., a structural member), such as through the second layer 672.

The second layer 672 of the heating element 670 may be made out of a thermally conductive and electrically insulating material, such as a ceramic. The second layer 672 may be configured to conduct the heat generated in the heating element 670 uniformly into the work piece. For example, the second layer 672 may be made from aluminum nitride (AlN) or another suitable material that is thermally conductive and electrically insulating. According to one example, the AlN second layer 672 may be configured having a thermal conductivity at room temperature of about 160-180 W/mK, an electrical resistivity at room temperature of about 10¹³ Ω·cm, and a thermal expansion coefficient of about 4-5 μm/m-° C.

The second layer 672 may be configured to be placed adjacent to, such as abutting or contact with, the work piece. In other words, the structural member may be in contact with second layer 672 where the heat induced by the heating element 670 (e.g., in the first layer 671) is configured to transfer, such as through conduction, from the second layer 672 to the structural member to heat treat the area that is adjacent to the second layer 672. For example, the portion of the structural member that is abutting the second layer 672 may be heat treated to form a heat treated area.

The shape of the second layer 672, such as the surface of the second layer 672 that is configured to contact the work piece, may be tailored to the contour or profile of the portion of the work piece that contacts the second layer 672. For example, the shape of the first layer 671 may complement the shape of the portion of the member that abuts the heating element 670 in order for the entire area of the surface of the first layer 671 to conduct heat into the member.

According to an exemplary embodiment, the first and second layers 671, 672 include materials having similar coefficients of thermal expansion. This arrangement may advantageously improve durability and longevity of the assembly utilizing the element 670, since the layers will expand at substantially similar rates during heating. For example, if the first and second layers of the element 670 are configured with different materials that have relative different coefficients of thermal expansion, then the layers will expand differently during heating (and cooling), which may damage the layers or may require the layers to be offset by a gap, which may reduce the efficiency of the conduction of heat between the layers. According to one example, the first layer 671 is made from TZM molybdenum and the second layer 672 is made from AlN, which have relatively similar coefficients of thermal expansion.

According to another exemplary embodiment, the second layer 672 may be provided on the work piece, rather than in the element 670 of the assembly (e.g., the assembly 560). In other words, the assembly 560 may be configured without the second layer 672, and the work piece may be configured having an outer layer (e.g., surrounding the work piece) that is electrically insulating and thermally conductive. For example, the work piece may be coated with an electrically insulating and thermally conductive material, such as AlN. The first layer forming the electrically conductive heating element (e.g., the first layer 571, the first layer 671, etc.) may be the inner layer of the assembly that is moved into and out of contact with the work piece to heat treat the work piece. The heat generated by the first layer is then passed into the outer layer of the work piece and into the inner layer of the work piece to heat treat at least a portion of the inner layer of the work piece. This arrangement may advantageously simply the design and construction of the assembly (e.g., the manufacturing equipment, tooling, etc.).

According to an exemplary embodiment, the second layer 672 is a thermal conductive coating that is applied via a spray process to either the work piece or the first layer 671. The AlN may be used with a binder to facilitate spraying of the coating, such as through a plasma sprayer. For example, a thermal conductive ceramic coating including AlN and yttrium stabilized zirconia (YSZ) having a volume ratio of 9:1 YSZ and AlN may be sprayed onto the TZM first layer 671, such as the first surface thereof. The YSZ/AlN coating may be formed having a thickness of about 1 mm. The second layer 672 may optionally be post processed, such as, for example, the layer may be machined to be flat or smooth. According to one example, the YSZ may be configured having a thermal conductivity at room temperature of about 1.8 W/mK, an electrical resistivity at room temperature of about 10⁷ Ω·cm, a thermal expansion coefficient of about 8-12 μm/m-° C., and have a service temperature of at least about 2000° C. The YSZ binder (e.g., used with the AlN) may advantageously be configured to operate at relatively high temperatures as an electric insulator and is relatively tough or durable as well.

The second layer 672 may include additional and/or different binders. For example, alumina may be used as a binder, such as with AlN. According to one example, the alumina may be configured having a thermal conductivity at room temperature of about 38 W/mK, an electrical resistivity at room temperature of about 10¹⁰ Ω·cm, a thermal expansion coefficient of about 5-8 μm/m-° C., and have a service temperature of at least about 1650° C. The alumina binder (e.g., used with the AlN) may advantageously improve the thermal conductance and maintain the electrical resistivity relative to YSZ, while having a coefficient of thermal expansion that is similar to that of the AlN. However, the alumina binder is not as durable or tough as the YSZ. Also, for example, alumina/titania may be used as a binder, such as with AlN. Alumina/titania has lower thermal conductivity and electrical resistivity properties relative to pure alumina, but has a higher coefficient of thermal expansion and has a lower service temperature (e.g., about 550° C.). Alumina/titania has a toughness or durability that is better than pure alumina, but is not as good as YSZ. Also, for example, a max phase ternary carbide (e.g., Ti₂AlC family of materials) may be used, which can be processed using a sprayer, such as a high velocity oxygen fuel (HVOF) sprayer. According to one example, the max phase ternary carbide may be configured having a thermal conductivity at room temperature of about 45 W/mK, an electrical resistivity at room temperature of about 10⁻⁸ Ω·cm, a thermal expansion coefficient of about 8-12 μm/m-° C., and have a service temperature of at least about 1100° C. The max phase ternary carbide has a relative high toughness or durability and thermal conductivity, but it is electrically conductive and has a lower service temperature.

The third layer 673 of the heating element 670 may be made out of an electrically conductive material that has relatively high corrosion resistance. For example, the third layer 673 may be made from copper, a copper alloy, or another suitable material that is electrically conductive and/or corrosion resistant. The third layer 673 may surround a portion of the second layer 672, such as one or more than one of the surfaces of the second layer 672 that are not in contact with the first layer 671. The third layer 673 may advantageously increase the longevity of the system by prohibiting or reducing the corrosion of the first layer 671. For example, if the first layer 671 is made from a material that tends to oxidize, then the third layer 673 may prohibit or reduce the oxidation of the first layer 671 by eliminating or reducing the exposure of the first layer 671 to an oxidizing environment (e.g. air).

According to an exemplary embodiment, the first layer 671 of the heating element reacts to current flow by generating heat, which is then directed into a work piece, such as through a thermally conductive layer (e.g., the second layer 672). The heating element 670 may, for example, be configured to reach temperatures of at least 800° C. in about fifty milliseconds (50 ms). The assembly (e.g., assembly 560) may be configured such that the work piece (e.g., a structural member) reaches a steady-state temperature in about three-hundred milliseconds (300 ms), such as for a back frame 446 that is about one millimeter (1.0 mm) thick. It is noted that the time to reach steady-state may increase for members that are thicker.

FIG. 14 is a schematic drawing showing another exemplary method or process of heat treating a structural member in the form a side member 346 to form one or more than one heat treated area 349 using an indirect resistance process. The thermal cycle of the indirect resistance method or process is relatively quick, and may form a martensitic microstructure in the heat treated area 349 of the side member 346 in less than one second. FIG. 14 also shows a graph of the electrode force and current over time for the indirect resistance heat treating cycle. According to an exemplary embodiment, the indirect resistance heat treating process involves a three step method.

In a first step of the process, the side member 346 is placed into the assembly 760, and in contact with at least one of the first and second heating elements 761, 762. In other words, in the first step, the assembly 760 is configured in the open position where the first and second heating elements 761, 762 are separated by a gap that is larger than the thickness of the work piece (e.g., the side member 346). Accordingly, there is zero pressure and zero current imparted to the side member 346 during the first step.

In a second step of the process, the assembly 760 is moved to the closed position, such that both the first and second heating elements 761, 762 are in contact with the work piece. For example, the first heating element 761 may be moved downwardly into contact with the side member 346 to clamp the side member 346 between the first and second heating elements 761, 762. It is noted that the second heating element 762 may be configured to move alone or in combination with the first heating element 761 to achieve the closed position of the assembly 760. Once both heating elements 761, 762 are in contact with the side member 346, then additional movement of at least one of the heating elements generates pressure into the side member 346. Additionally, once both of the heating elements are in contact with the work piece, then the assembly 760 may be configured to pass an electric power through the heating elements, such as the electrically conductive layers of the heating elements to generate the heat that is used to heat treat the side member 346.

During the third step of the process, at least one of the first and second heating elements 761, 762 is moved toward the other heating element to increase the pressure on the side member 346. Also during the third step, a level of current, such as an increasing level of current, is passed through the heating elements 761, 762 to generate heat that is in turn conducted into the work piece, such as, for example, into the surfaces of the side member 346 that are in contact with the conductive layers (e.g., the first layers) of the heating elements. The heat generated by the heating elements may be increased during the third step, such as, in proportion to the increasing current passing through the heating elements. The heat is directed into the heat treated area 349 of the side member 346 to increase the temperature of the side member 346 to induce a heat treatment of the side member 346. For example, the temperature of the material of the side member 346 local to the heat treated area 349 (e.g., proximate to the heating elements) may be raised or elevated to a temperature above the lower critical temperature, such as to approximately 910° C. (1670° F.) in a time (e.g., less than one second) to convert the steel to austenite. The time in which the temperature of the side member 346 is raised above the lower critical temperature may preferably be very short, such as, for example, in milliseconds.

The indirect resistance heat treating process may include additional steps. For example, the indirect resistance heat treating process may involve a fourth step, a fifth step, and/or a sixth step. In the fourth step of the process, the heat treated area 349 of the side member 346 is rapidly cooled from austenite to form a martensitic and/or bainitic microstructure in a quench cycle. The quench cycle may be done external to the fixture (e.g., the assembly 760) or may be integrated with the fixture. The quench cycle may use any suitable quench fluid (e.g., air, water, oil, etc.). The parameters of the quench cycle (e.g., fluid, time, etc.) may be varied in order to tailor the microstructure of the heat treated area 349 of the side member 346.

In the fifth step of the process, the side member 346 may be tempered or annealed. For example, the heat treated area 349 of the side member 346 may be tempered by heating the heat treated area 349 to a temperature (e.g., a temperature below the lower critical temperature). The side member 346 may be tempered to increase the toughness of the side member 346, since heat treating may increase the brittleness as well as the strength of the side member 346.

In the sixth step of the process, at least one of the first and second heating elements 761, 762 is moved away from the other heating element to move the assembly (e.g., the assembly 560) from the closed position to the open position to allow for the side member 346 to be moved or removed from the fixture. For example, the side member 346 may be moved in order to form another heat treated area, to form another element or feature in the structural member, or to remove the part, if completed.

It is noted that although the assembly 760 is disclosed as having first and second heating elements 761, 762, the assembly 760 may be configured having only a single heating element. The assembly having a single heating element may heat treat the structural member from one side thereof. However, the assembly 760 having at least two heating elements that are configured to heat treat a work piece from opposing sides (e.g., a top and a bottom of the work piece) may advantageously provide a better heat treat condition, such as by having a generally uniform level of treatment through the thickness of the work piece, since it is treating the work piece from both sides, as opposed to just one.

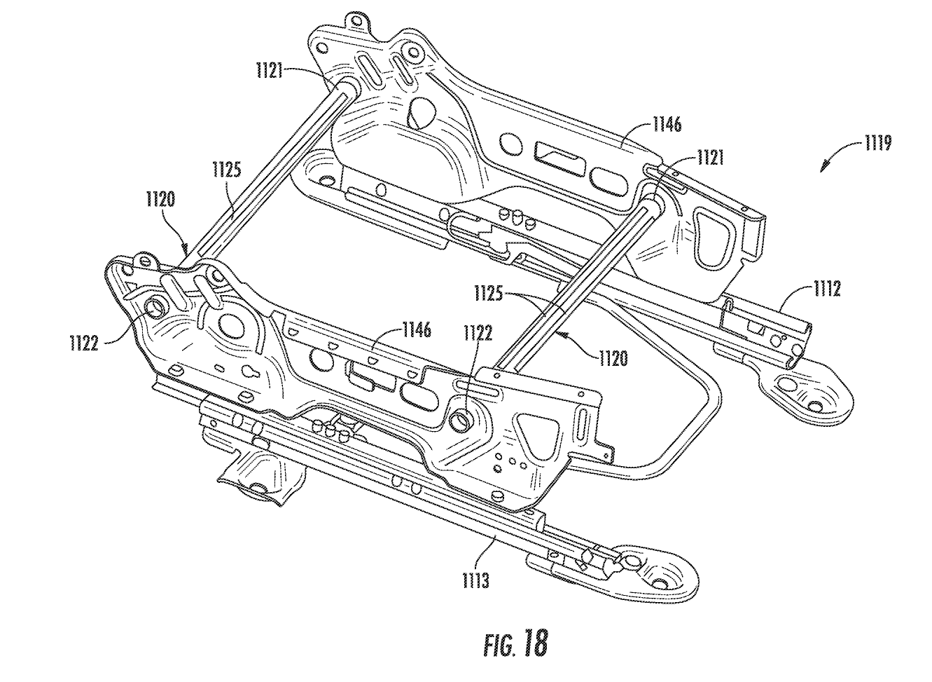

FIG. 15 is a schematic diagram showing an exemplary embodiment of an indirect resistance system 860 for locally hardening a structure, such as the heat treated area 349 of the side member 346. As shown, the system 860 includes a pair of opposing heating elements 870 that are configured to receive electric power from a power supply 863 through electric connections 864. The power supply 863 is configured to produce an electric current I, which passes through the second layer 872 of each heating element 870 to generate heat, which is then conducted into the side member 346 through the first layer 871 of each heating element 870. For example, the system 860 may be configured to move between an open position (as shown in FIG. 15), in which the first layers 871 of the heating elements 870 are separated from the side member 346, to a closed position, in which the first layers 871 are in contact with at least a portion of the side member 346. When in the closed position, the heat generated is able to pass from the first layers 871 into the side member 346 through conduction to locally heat treat the effected area. Thus, the heat generated in the system 860 is used to heat treat the heat treated area 349 of the side member 346. It is noted that the system may be configured differently than disclosed herein, and in particular the power supply device may be differently configured. Additionally, the system 860 may include a greater or fewer number of heating elements.

It is noted that although FIGS. 14 and 15 illustrate the side member 346, any structural member may be utilized in the indirect resistance process disclosed herein to provide a heat treated area to tailor the strength of the member. Thus, the processes disclosed herein are not limited to the structural members disclosed.

It is also noted that the assembly, such as the indirect resistance assembly, that forms and heat treats the work piece may advantageously improve the formability of certain materials, such as difficult to form materials. For example, aluminum, magnesium, titanium, high strength steels, dual phase materials, as well as other low formability materials may be easier to form using a fixture that heats the part using indirect resistance while forming the work piece using pressure. The indirect resistance assembly may heat the hard to form material to a temperature that improves formability, but may not necessarily change the microstructure of the material/part.

FIG. 16 illustrates a structural member in the form of a seat member 946 that is configured having a tailored strength. The seat member 946 may be a formed member (e.g., stamped, feinblanked, etc.), such as from a sheet of material (e.g., steel), which may be used in place of a tubular member (e.g., tubular frame 19). The seat member 946 may have a first side 951, a second side 952, and an intermediate section 953 extending between the sides. The intermediate section 953 may be used to support the occupant seated on the seat assembly, wherein the weight from the occupant is transferred to the sides 951, 952.

The seat member 946 may include a heat treated area that is configured to tailor the strength of the seat member 946 local to the area. As shown, the seat member 946 includes a first heat treated area 949a and a second heat treated area 949b that is provided offset from the first heat treated area 949a. For example, the heat treated areas 949a, 949b may be configured to extend generally parallel in the intermediate section 953 between the sides 951, 952. According to one example, the first heat treated area 949a has a length between 250-350 mm and a width between 15-40 mm. More preferably, the first heat treated area 949a may have a length of about 300 mm and a width of about 25 mm. According to one example, the second heat treated area 949b has a length between 200-300 mm and a width between 10-30 mm. More preferably, the second heat treated area 949b may have a length of about 250 mm and a width of about 20 mm.

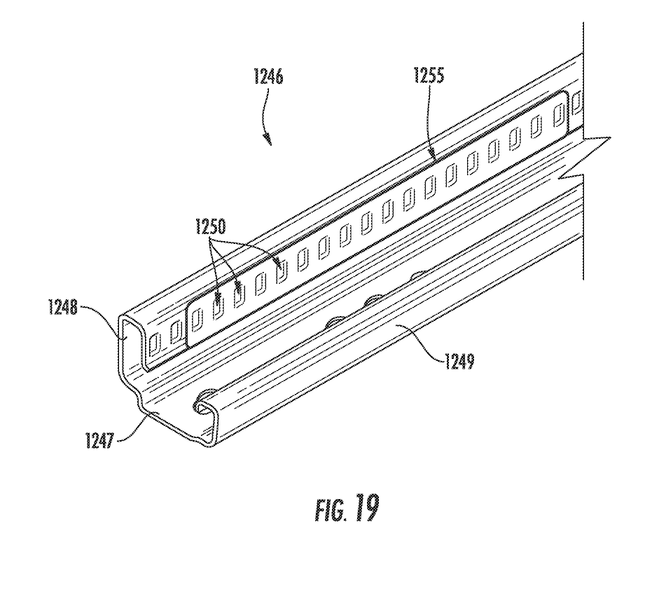

FIG. 17 illustrates a structural member in the form of a headrest rod 1046 (e.g., post, etc.) that is configured having a tailored strength. The headrest rod 1046 may have any general configuration (e.g., shape, size), which may be tailored to the specific seat assembly. As shown, the headrest rod 1046 is made from a wire (e.g., rod) material (e.g., steel) having a generally circular cross-sectional shape, where the headrest rod 1046 is formed into a generally inverted U-shape. A portion of the headrest rod 1046 may be heat treated, using any suitable method disclosed herein, to have one or more than one heat treated portion 1049. According to one example, each heat treated portion 1049 of the headrest rod 1046 has a length between 40-60 mm, and more preferably, the length is about 50 mm. The heat treated portion 1049 may extend through the entire thickness of the rod along the length, or may extend partially into the rod (e.g., a surface treatment). The heat treated portion 1049 may advantageously be provided through the portion of the headrest rod 1046 that includes locking features that are configured to adjustably position the headrest assembly in place relative to the seat assembly, such as the seat back. The locking features may include notches (e.g., grooves, etc.) that are configured to receive an engaging mechanism to adjustably lock the headrest rod 1046 in place at various heights relative to the seat back. The notches may induce a stress riser under loading of the headrest. The heat treated portion 1049 may increase the strength of the headrest rod 1046, and may counter the notches provided therein.

FIG. 18 illustrates another exemplary embodiment of a seat structure 1119 having a member with a tailored strength. As shown, the seat structure 1119 includes a pair of spaced apart side members 1146 that are coupled to a pair of spaced apart track assemblies 1112, 1113, and also includes a pair of spaced apart cross tubes 1120 extending between the side members 1146. The coupled side members 1146 and cross tubes 1120 form a structure that is configured to transfer loading (e.g., induced by an occupant during a dynamic vehicle event) to the vehicle through the track assemblies 1112, 1113.

Each cross tube 1120 may be generally cylindrical (e.g., tubular) in shape extending between a first end 1121 and a second end 1122, where each end may be coupled to one of the two respective side members. Each cross tube 1120 may be coupled to the respective side member through welding (e.g., MIG, laser, etc.), forming (e.g., swaging, cold working, etc.), or through any suitable process that couples the tube and member in a structural manner.

Each cross tube 1120 may have a tailored strength, which may be formed through any method disclosed herein. For example, each cross tube 1120 may have a heat treated area that extends circumferentially (e.g., semi-circumferentially) around a portion (e.g., a circular portion, a semi-circular portion, etc.) of the tube. Also, for example, each cross tube 1120 may have a heat treated area that extends longitudinally (i.e., along the length of the tube), such as between the first and second ends 1121, 1122 of the tube.

According to an exemplary embodiment, each cross tube 1120 includes a plurality of longitudinal heat treated areas, which are spaced apart circumferentially (e.g., separated by an arc length or angle around the periphery of the tube). As shown in FIG. 18, each cross tube 1120 includes four heat treated areas 1125, which are spaced apart by an angle between a center of each heat treated area 1125. For example, the angle may be equal to about 90° (ninety-degrees), such that all four of the heat treated areas 1125 are spaced apart at equal distances around the tube. The size (e.g., length, width, etc.) of each heat treated area 1125 may be tailored depending on the application. According to one example, each heat treated area 1125 is between 250-350 mm in length and 8-16 mm in width. More preferably, each heat treated area 1125 is about 300 mm in length and 12 mm in width. It is noted that each cross tube 1120 may be configured having a cross sectional shape other than circular and still be configured having a tailored strength.

Each side member 1146 may be configured having a tailored strength, which may be formed through any method disclosed herein. Further, each side member 1146 may have a strength that is tailored according to any side member (e.g., the side members 146, 346, etc.) disclosed herein. Additionally, other elements (e.g., members, etc.) of the seat structure 1119 may be configured having a tailored strength. For example, the track assemblies 1112, 1113 may be configured having elements with a tailored strength.

FIG. 19 illustrates a structural member in the form of a track rail 1246 that is configured having a tailored strength. The track rail 1246 may be configured for use in a track assembly (e.g., the track assemblies 1112, 1113), such as to provide adjustability to a seat assembly. For example, each track assembly may include a pair of rails (e.g., an upper rail and a lower rail) that are selectively adjustable relative to one another. In other words, the rails may move (e.g., slide) relative to each other.

As shown, the track rail 1246 includes a base 1247, a first leg 1248, and a second leg 1249 spaced apart from and opposing the first leg 1248. The base 1247 may be configured to attach (e.g., couple) the rail to another member of the seat assembly or to the vehicle. Both of the first and second legs 1248, 1249 may be configured having generally J-shaped cross sections, which may be similarly configured or differently configured (as shown in FIG. 19). One or both legs 1248, 1249 may include features that are configured to help lock the track rail 1246 (e.g., the lower rail) to the other rail of the track assembly (e.g., the upper rail), such as through a locking mechanism (e.g., locking pawl). As shown, the J-shaped first leg 1248 has an outer wall and an inner wall spaced apart from the outer wall, where the inner wall has a plurality of openings 1250 that are configured to receive the locking mechanism to selectively couple the two rails together. For example, the locking pawl may include one or more than one tooth that extends through one or more than one opening 1250 in the track rail 1246 and also extends through one or more opening in the other track rail to lock the relative relationship of the two rails. Thus, during loading of the track assembly, the inner wall of the first leg 1248 is in the load path. Accordingly, it would be advantageous to tailor the strength of each rail (e.g., the track rail 1246) local to the loading to increase the strength of the rail and the track assembly.

According to one example, the track rail 1246 includes a heat treated area 1255 provided on the inner wall of the first leg 1248 around the plurality of openings 1250. The heat treated area 1255 may be configured to cover all of the plurality of openings 1250 or a portion thereof. The size (e.g., length, width, etc.) of the heat treated area 1255 may be tailored, such as to the size of the track rail 1246 and/or features thereof (e.g., the size of the openings). According to one example, each heat treated area 1255 is between 6-10 mm in width, and more preferably, each heat treated area 1255 is about 8 mm in width.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or movable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the seat structures or assemblies having heat treated zones as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments.

Other substitutions, modifications, changes and omissions may also be made in the design, operating conditions and arrangement of the various exemplary embodiments without departing from the scope of the present invention. For example, one element (e.g., feature, layer, component, etc.) that is disclosed for use in one embodiment may be used with any other embodiment disclosed herein.

What is claimed is:

1. A method of locally heat treating a structural member of a seat assembly for a vehicle component, comprising:
placing the structural member into a fixture including a first element having a first layer that is electrically conductive and a second element having a first layer that is electrically conductive;
moving at least one of the first and second elements into contact with the structural member;
imparting a pressure into the structural member by at least one of the first and second elements;
passing an electric current through the electrically conductive first layers of the first and second elements to provide at least one heat treated area in the structural member; and
stopping the current and releasing the pressure from the structural member.

2. The method of claim 1, wherein the electrically conductive first layers of the first and second elements are in contact with the structural member when the current is passed through the electrically conductive layers, such that the current also passes into the structural member, and wherein the first and second elements contact opposing surfaces of the structural member.

3. The method of claim 2, wherein the current is a single pulse of current that is provided in less than one second.

4. The method of claim 1, wherein a second layer is disposed between at least one of the first layers and the structural member, wherein each second layer is a thermally conductive and electrically insulating layer, and wherein the second layers of the first and second elements are in contact with the structural member, such that current does not pass into the structural member.

5. The method of claim 4, wherein the second layer is provided on the at least one of the first layers.

6. The method of claim 4, wherein the second layer is a coating provided on the structural member.

7. The method of claim 4, wherein each of the first and second elements also include a third layer provided on the electrically conductive first layer, and wherein the third layer is an electrically conductive and corrosion resistant layer, and wherein each third layer is made from a material that is different than a material of the first layer on which the third layer is provided.

8. The method of claim 4, wherein the first layer and the second layer have substantially similar coefficients of thermal expansion.

9. The method of claim 8, wherein the first layer comprises a TZM molybdenum and the second layer comprises an aluminum nitride.

10. The method of claim 1, further comprising the steps of cooling the structural member via a coolant and tempering the structural member.

11. The method of claim 1, wherein the fixture also includes a first die portion and a second die portion that are configured to form a geometric feature of the structural member through pressure.

12. The method of claim 11, wherein the structural member is one of a side member and a back frame member that is configured to mount to a seat back reclining mechanism at an attachment location, and wherein the one of the side member and the back frame member includes a plurality of heat treated areas that are configured to induce a buckling zone that is provided adjacent to the attachment location upon loading of the structural member by a predetermined load.

13. The method of claim 12, wherein at least one heat treated area is provided on a first side of the structural member and at least one heat treated area is provided on a second side of the structural member, and wherein the first and second sides of the structural member are disposed in different planes.

14. A vehicle seat structure comprising:
a structural member having a heat treated zone including at least one heat treated area, such that the at least one heat treated area has a strength that is different than the strength of a non-heat treated area of the structural member;
wherein the at least one heat treated area is arranged to provide load path management during loading of the structural member by defining a buckling zone configured adjacent to the heat treated zone.

15. The vehicle seat structure of claim 14, wherein the plurality of heat treated areas are provided adjacent to an attachment location configured to couple a second structural member to the structural member.

16. The vehicle seat structure of claim 15, further comprising a third structural member having a heat treated zone including a plurality of heat treated areas provided adjacent to an attachment location configured to couple the third structural member to the second structural member, and wherein the plurality of heat treated areas of the third structural member have a microstructure that is different than the microstructure of the non-heat treated areas of the third structural member.

17. The vehicle seat structure of claim 16, wherein the structural member is a side member of a cushion structure, the second structural member is a seat back adjustment mechanism, and the third structural member is a back frame member, and wherein the side member and the back frame member each includes at least one heat treated area that is provided adjacent to an attachment of the seat back adjustment mechanism, such that the heat treated areas are configured to induce a buckling zone that is provided adjacent to the attachment locations upon loading of the seat structure by a predetermined load.

18. The vehicle seat structure of claim 17, wherein the back frame member includes at least two heat treated areas that are spaced apart by a distance of between 20-30 mm, and wherein each heat treated area of the back frame member has an area of between 3-79 mm², and wherein the side member includes at least two heat treated areas that are spaced apart by a distance of between 8-20 mm, and wherein each heat treated area of the side member is generally circular in shape having a diameter of between 2-10 mm.
